(19) United States
(12) Patent Application Publication
(10) Pub. No.: US 2026/0023925 A1
(43) Pub. Date: Jan. 22, 2026

(54) SYSTEM AND METHOD FOR EXTERNAL VEHICLE MAPPING

(71) Applicants: Sam Hijazi, Austin, TX (US); Ahmad El Solh, Austin, TX (US); Nilesh Patel, Glendale, CA (US); Christopher Reynoso, Austin, TX (US)

(72) Inventors: Sam Hijazi, Austin, TX (US); Ahmad El Solh, Austin, TX (US); Nilesh Patel, Glendale, CA (US); Christopher Reynoso, Austin, TX (US)

(21) Appl. No.: 19/340,040

(22) Filed: Sep. 25, 2025

Related U.S. Application Data
(63) Continuation of application No. 17/830,242, filed on Jun. 1, 2022, now abandoned.

(51) Int. Cl. G06F 40/216; G06Q 30/0601

(52) U.S. Cl. CPC G06F 40/216; G06Q 30/0603

(57) ABSTRACT

A system, method, and computer-readable medium are disclosed for external vehicle mapping. A computer system receives vehicle data from one or more external sources, including manufacturer databases, dealership management systems, government records, or vehicle identification codes. A mapping module normalizes the received data into a standardized data structure representing vehicle features, options, or packages. The standardized data is stored in an inventory database and provided to dealership systems, advertising platforms, or third-party applications through an inventory management interface. The mapping module may apply natural language processing, rule-based translation, and machine learning to reconcile inconsistent or incomplete data across manufacturers and sources. A feedback interface allows operators to correct or confirm mappings, enabling continuous refinement of rule sets and predictive models. The invention improves the accuracy and consistency of vehicle feature representation across diverse inventories, thereby enhancing dealership efficiency, consumer transparency, and integration with external systems.

### CROSS-REFERENCE TO RELATED APPLICATIONS

The present application claims priority to U.S. Provisional application Ser. No. 17/830,242 filed Jun. 1, 2022, titled “SYSTEM AND METHOD FOR EXTERNAL VEHICLE MAPPING,” which is hereby incorporated by reference in its entirety.

### TECHNICAL FIELD

The embodiments generally relate to the technical field of computer-implemented systems and methods for external vehicle mapping.

### BACKGROUND

Automobile and other vehicle sales often occur at centralized locations called dealerships. Dealerships, or car dealers as they are known in the automobile industry, are merchants who specialize in the buying, selling, trading, and leasing of various types of vehicles. The stock or collection of vehicles sold at any particular dealership may include a wide array of new and/or used vehicle makes and manufacturers (e.g., Dodge, Jeep, Oldsmobile, Toyota, Fiat, Chrysler, Mercedes, or many others).

Different manufacturers or car companies may stylize vehicle features, components, and accessory packages in different ways for sales and marketing purposes. For instance, one car company may offer an air-conditioned seat as part of the features package, while another company may offer the same feature and call it a ventilation package. As such, there is a lack of standardizations for automobile vehicle mapping features.

A dealership that may potentially sell new vehicles from a single manufacturer, used cars from that same manufacturer, and used cars released by other manufacturers may not have accurate standardization of vehicle data across this diverse stock of inventory. This lack of accurate data hinders dealerships in providing consistent information when offering used vehicles for sale, since customers may request or require particular features or packages. While window stickers, VIN numbers, or other identifying information can be used to identify specific vehicles, dealers may still not have total accuracy in their systems. Therefore, the use of computer-implemented systems and methods for mapping features to common standardized terms would be highly beneficial for analysis and management in this context.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

The present system provides a variety of concepts in a simplified form that are further described in the detailed embodiments. This invention relates to external vehicle mapping inventory management and analysis. Generally, the embodiments use mapping of vehicle information by performing one or a series of operations on the vehicle data and building or enhancing an inventory management system for use by dealerships and/or third parties.

The system relies on a defined set of data that is desired, required, and/or acceptable to a third-party remote system. Data that was previously stored in a non-standard format may be cleaned, processed, and organized to match the desired set. The result is accurate vehicle representation in the database, which can then be used to manage inventory and perform robust analysis.

Systems and methods implemented herein may determine characteristics, features, components, options, and packages for various vehicles at dealerships. Organizing and standardizing data allows dealerships to understand their inventory better. Such data can be stored in formats amenable to modern data processing operations such as machine learning, natural language processing, and application of rules.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a system architecture diagram of the network of the invention.

FIG. 2 illustrates an external vehicle mapping process flowchart.

FIG. 3 illustrates a code for adding VIN data to a system.

FIG. 4 illustrates an advertising site wireframe.

FIG. 5 illustrates data parsed into an inventory matching system wireframe.

FIG. 6 illustrates a flowchart of system operation.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The embodiments generally relate to systems, methods, and computer-readable media for external vehicle mapping. The invention enables the collection, normalization, and dissemination of vehicle information obtained from diverse sources, thereby allowing dealerships and third parties to manage, compare, and present standardized vehicle feature data. By transforming inconsistent and heterogeneous data into a structured and uniform format, the invention provides improved accuracy, efficiency, and transparency in vehicle inventory management.

In one embodiment, the system comprises a computer system having one or more processors, memory, and a network interface. The computer system executes a set of functional modules that perform vehicle data acquisition, data normalization, and standardized data output. A data acquisition module is configured to receive vehicle information from a plurality of external sources. Such sources may include manufacturer databases, dealership management systems, government motor vehicle records, auction or resale listings, service and repair records, or vehicle identification data encoded in VINs or QR codes. The data acquisition module is capable of ingesting structured, semi-structured, or unstructured information.

A mapping module is configured to normalize vehicle information received from the data acquisition module into a standardized data structure. Vehicle features, options, and packages described differently across sources are reconciled into uniform categories. The mapping module may employ natural language processing to analyze unstructured text, rule-based translation to apply consistent mappings, and machine learning models to predict missing or ambiguous data fields. The mapping module thereby ensures that equivalent features, such as “ventilated seats” and “air-conditioned seats,” are standardized into a common representation.

An inventory management interface is configured to provide the standardized vehicle data to internal and external systems. The interface may transmit the data to dealership inventory systems, advertising platforms, or third-party dealer management services. The interface may also generate data feeds in formats such as XML, JSON, or CSV for use in consumer-facing portals, auction systems, or financing platforms.

The system is capable of processing diverse vehicle data through multiple stages. First, raw data is acquired from at least one external source. Next, the mapping module applies one or more normalization operations, which may include parsing, categorization, equivalence mapping, and machine learning-based prediction. The standardized data is then stored in an inventory database. Finally, the standardized data is provided to internal or external systems for use in inventory analysis, customer presentations, or integration with third-party applications.

In certain embodiments, a rule set repository stores mapping rules that define associations between manufacturer-specific terminology and standardized feature categories. The repository may be continuously updated based on operator input, customer feedback, or machine learning analysis. A machine learning engine may analyze discrepancies between raw and standardized data to refine mappings and predict missing feature data. Over time, this process improves mapping accuracy and adaptability as new features and terminology are introduced into the marketplace.

The system may include a feedback interface allowing operators to confirm, correct, or supplement standardized data. Corrections provided through the feedback interface may be recorded and used to retrain machine learning models or to update mapping rules. This creates a continuous improvement loop whereby the system adapts to evolving manufacturer terminology, dealership practices, and customer expectations.

The invention further encompasses a computer-readable medium storing instructions that, when executed by one or more processors, cause the processors to carry out the described operations. The instructions may include receiving raw vehicle data, applying normalization processes, storing standardized data, and transmitting standardized data to external systems. Such instructions may be embodied in non-transitory storage media, including flash memory, magnetic storage, optical storage, or other suitable media.

The described system provides numerous advantages over conventional vehicle inventory management practices. By ensuring that vehicle features are consistently represented across manufacturers, dealerships, and sales platforms, the invention improves the accuracy of inventory listings, reduces confusion for customers, and enhances dealership efficiency. The ability to apply natural language processing, machine learning, and rule-based normalization allows for robust standardization even when input data is incomplete or inconsistent. The inclusion of operator feedback ensures adaptability, enabling the system to evolve as new vehicles and features enter the marketplace.

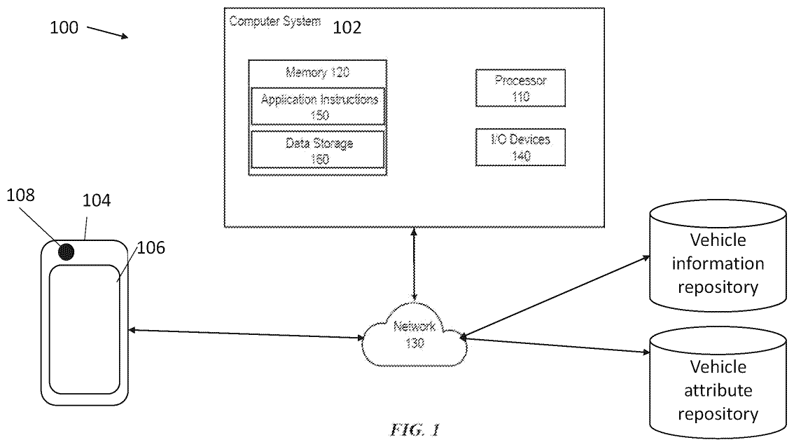

FIG. 1 illustrates a system architecture diagram 100, including a computer system 102, which can be utilized to provide and/or execute the processes described herein in various embodiments. The computer system 102 can be comprised of a standalone computer or mobile computing device, a mainframe computer system, a workstation, a network computer, a desktop computer, a laptop, a tablet, a smartphone, a videogame console, or the like. The computer system 102 includes one or more processors 110 coupled to a memory 120 via an input/output (I/O) interface. Computer system 102 may further include a network interface to communicate with the network 130. One or more input/output (I/O) devices 140, such as video device(s) (e.g., a camera), audio device(s), and display(s) are in operable communication with the computer system 102. In some embodiments, similar I/O devices 140 may be separate from computer system 102 and may interact with one or more nodes of the computer system 102 through a wired or wireless connection, such as over a network interface. In many embodiments, computer system 102 can be a server that is fully automated or partially automated and may operate with minimal or no interaction or human input during processes described herein. As such, many embodiments of the processes described herein can be fully automated or partially automated.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 102 and other devices attached to a network 130, such as other computer systems, or between nodes of the computer system 102. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel storage area networks (SANs), or via any other suitable type of network and/or protocol.

The memory 120 may include application instructions 150, configured to implement certain embodiments described herein, and at least one database or data storage 160, comprising various data accessible by the application instructions 150 In at least one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL@, etc.).

The steps and actions of the computer system 102 described in connection with the embodiments disclosed herein may be embodied directly in hardware, in a software module executed by a processor, or in a combination of the two. A software module may reside in random access memory (RAM), flash memory, read-only memory (ROM) memory, erasable programmable read-only memory (EPROM) memory, electrically erasable programmable read only memory (EEPROM) memory, registers, a hard disk, a solid-state drive (SSD), hybrid drive, dual-drive, a removable disk, a compact disc read-only memory (CD-ROM), digital versatile disc (DVD), high definition digital versatile disc (HD DVD), or any other form of non-transitory storage medium known in the art or later developed. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, Bluetooth, Wi-Fi, microwave, or others, then the coaxial cable, fiber optic cable, twisted pair, DSL, or wireless technologies such as infrared, radio, Bluetooth, Wi-Fi, microwave, or others can be included in the definition of medium. “Disk” and “disc,” as used herein, include compact disc (CD), laser disc, optical disc, digital versatile disc (DVD), floppy disk, and Blu-ray disc or others where disks usually reproduce data magnetically, while discs usually reproduce data optically with lasers. Combinations of the above should also be included within the scope of computer-readable media.

It should be understood by those in the art that computer system 102 also includes power components that are operably coupled such that the system is operable. This can include one or more batteries if computer system 102 is mobile.

In some embodiments, the system is world-wide-web (www) based, and the network server is a web server delivering HTML XML, etc., web pages to the computing devices. In other embodiments, a client-server architecture may be implemented, in which a network server executes enterprise and custom software, exchanging data with custom client applications running on the computing device 102.

As shown in the example embodiment, a mobile computing device 104 can also be communicatively coupled with and exchange data with network 130. Those in the art will understand that mobile computing device 104 can include some or all of the same or similar components as computer system 102 coupled to constitute an operable device. Mobile computing device 104 can be a personal digital assistant (PDA), smartphone, tablet computer, laptop, wearable computing device such as a smartwatch or smart glasses, or other device that includes one or more user interface 106, such as a touchscreen and/or audio input/output and/or other display and user input components. Mobile computing device 104 can also include one or more image capturing or reading component 108 (e.g. a digital camera, scanner, or others) and associated structures and elements operatively coupled to at least one processor and memory of the mobile computing device. Such image capturing component 108 can be operable to capture an image of a label and/or code (e.g. a quick response (QR) code or others) automatically or upon one or more user input commands.

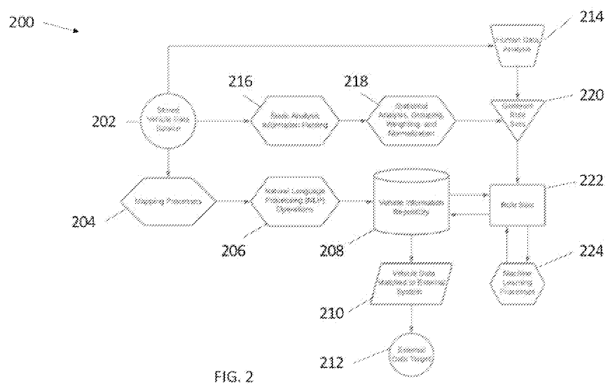

FIG. 2 illustrates a flowchart 200 of an external vehicle mapping process, according to some embodiments. In an example embodiment, stored vehicle data source 202 can include vehicle data as entered by dealership employees or others; gathered from or sent by manufacturers, dealers, automobile repair shops, aftermarket parts dealers and installers, and other databases; scanned from QR or other codes that may be located on window stickers or other locations; or others. Information in addition to characteristics, features, options, packages, and other data for vehicle data source 202 can include data such as make, model, color, accessories, recall history, Department of Motor Vehicle (DMV) information, and/or other information that may be individually associated with each vehicle. This information/data can be located in one or more locations such as non-transitory computer readable memory stored database(s) and may include information gathered from one or more locations, electronic databases and communications, or others. In some instances data stored in vehicle data source 202 can be purchased or subscribed to, or otherwise available for use by one or more parties.

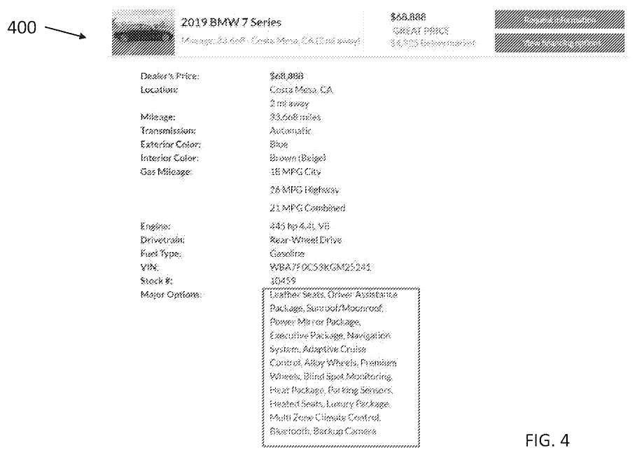

Data from a stored vehicle data source 202 can be sent to, pushed to, pulled from storage, or otherwise accessed and used by mapping processes 204. Mapping processes can include one or more steps or operations by which data is mapped to useful and/or logical locations. In some embodiments, mapping operations can include associating data about individual vehicle features and packages to a standardized template or index (see FIG. 4 and associated description for additional information). Such information can then be usable by the system and/or third-parties for a variety of useful operations.

Mapping processes 204 can be subjected to or run through natural language processing (NLP) operations 206. These natural language processing operations 206 can include using one or more models or trained interpretation operations to glean useful data and/or otherwise organize such data from an informal or non-standardized dataset into a formal and standardized organization scheme. For example, certain words, phrases, figures of speech, shorthand references, colloquialisms, or other informal language may be used to describe identical information in many different ways. Although a human may understand some, many, or all of the informal language used, the data can be better used by computing systems once it has organized it into a standardized format. As an example, a window on the roof of a vehicle that can be operably opened by a driver may be called a moon roof by some manufacturers, while some members of the general public may refer to it as a sunroof, which typically is opaque and does not refer to the exact same feature. Similarly, humans might refer to a feature in a single manner, while individual manufacturers may refer to the feature in many different manners. Machine learning, artificial intelligence, and/or physical updates by a human system user can all be used to organize data in various embodiments, and standardize the data for storage and use by the system.

Results from NLP operations 206 can be stored in vehicle information repository 208 Vehicle information repository 208 can be one or more databases stored in non-transitory computer readable memory on a server or other computing device that is locally accessible or remotely accessible via a network by computing devices. Data can be stored in any number of useful logical formats. Vehicle information repository 208 is typically part of the system in many embodiments.

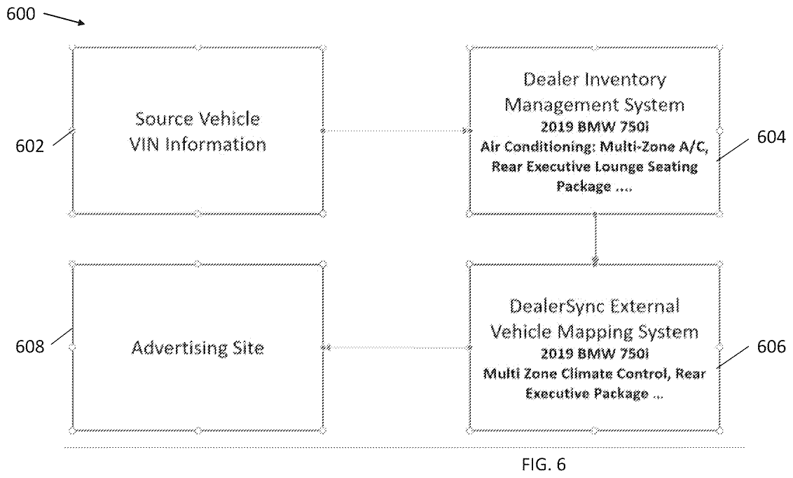

Vehicle data stored in vehicle information repository 208 can then be accessed by or otherwise used by the system, such as by matching the data to an external system 210. In some embodiments, this external system 210 could be a third party mapping software system that is accessible via a computer network (see FIG. 6 and associated description for additional information).

Finally, vehicle data matched to an external system in 210 can be outputted or otherwise used by at least one external data target 212. This could include transmitting to or making the data available to one or more third-parties, providing real-time update for a server, storing for later internal system use, or many others. In some embodiments external data target 212 can be a system of a third-party site and may add internal system XML or other data from a VIN provider (see FIG. 4 and associated description for additional information).

Data from stored vehicle data source 202 can be used in human data analysis 214. As such, humans are able to tag, edit, modify, interpret, and otherwise work with the data. This can include determining and implementing basic ruleset(s) and exceptions to such ruleset(s) (also known as outliers).

Likewise, data from stored vehicle data source 202 can be used or subjected to static analysis information parsing 216 After static analysis information parsing 216, statistical analysis, grouping, weighting, and normalization operations are conducted in step 218 Here, human reviewed ruleset(s) that are generated from the mapping processes for the purpose of weighting and adjusting ruleset(s) can be used to cover or otherwise interpret ambiguous inputs and outliers.

Results of one or both of human data analysis 214 and statistical analysis, grouping, weighting, and normalization operations from step 218 can function as inputs to generate rule sets 220, resulting in applicable and usable rule sets 222. For example, manual injection by a human for one-off or single instance data can be performed in order to ensure accuracy. Here, a description such as “cool blue seats” may not actually mean ventilated or cooled seats, but might indicate a color package instead.

Rule sets 222 can be sent to and used in a feedback loop with machine learning processes 224. Rule sets 222 can also access from and write data to vehicle information repository 208. As such, rule sets 222 data can be run through machine learning processes that may further refine, develop, create, or modify rule sets 22Z which may then be used in further machine learning processes 224 for even more detailed and/or robust results. Rule sets 222 may also use data from vehicle information repository 208 that can then be run through machine learning processes 224, which can be from Google APIs and others.

A variety of machine learning processes can be employed in the systems and methods herein. These can include supervised learning (e.g. for classification and others), which can be used to create one or more ruleset(s), to process vehicle information (e.g. trim, color scheme(s), drivetrain, engine attributes, options, optional packages, specifications, styles, supported fuel types, transmission, and others). In various embodiments, each iteration may generate additional rules for identifying potential matches based on the associated options.

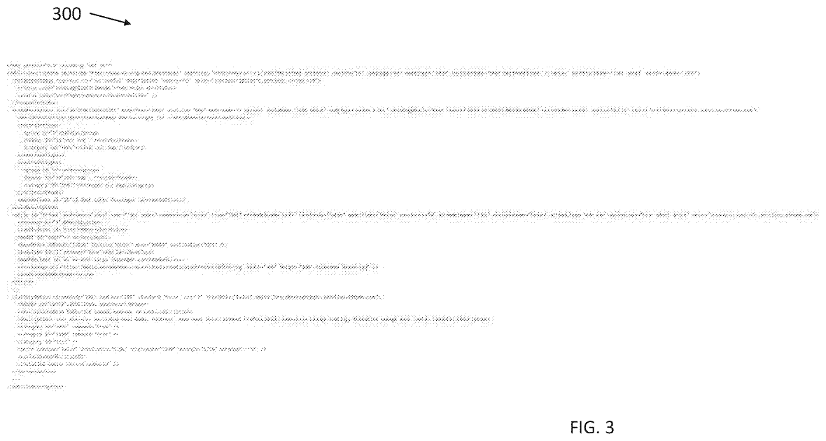

FIG. 3 illustrates code 300 for adding VIN data to a system, according to some embodiments. As shown in the example embodiment, VIN data and associated information about packages, features, and components, as well as images, can be stored in the system.

FIG. 4 illustrates an advertising site wireframe 400, according to some embodiments. As shown in the example embodiment, various information can be included about a vehicle including price, location, color, gas mileage, engine, fuel type, VIN, and others. Options that may require external mapping can be included as a “major options” field, and may include leather seats, driver assistance package, sunroof/moonroof, power mirror package, executive package, navigation system, adaptive cruise control, alloy wheels, premium wheels, blind spot monitoring, heat package, parking sensors, heated seats, luxury package, multi zone climate control, Bluetooth, backup camera, and/or others.

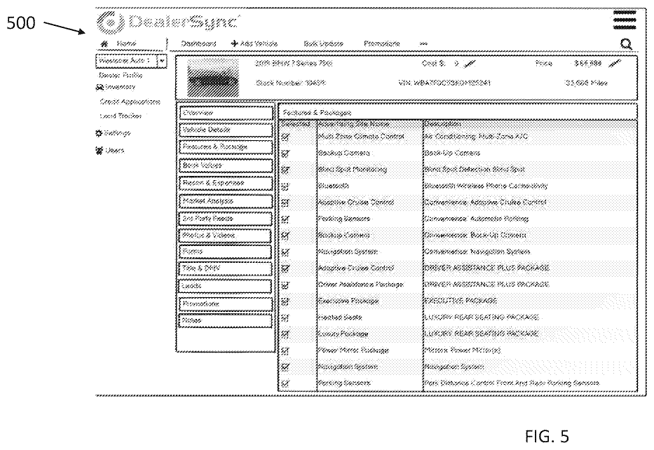

FIG. 5 illustrates data parsed into an inventory matching system wireframe 500, according to some embodiments. As shown in the example embodiment, features on an advertising site may have a particular name while the description may further elaborate on exactly what that name means for a particular vehicle.

FIG. 6 illustrates a flow chart 600; according to some embodiments. As shown in the example embodiment, source vehicle information 602 can be associated with or stored by dealer inventory management system (e.g. that a particular 2019 BMW 750i vehicle information included air conditioning with multi-zone AC and a rear executive lounge seating package) in 604. This information can be run through the external mapping operations disclosed herein in 606 (e.g. that the external system calls the packages simply multi zone climate control and rear executive package). Next, in 608, results can be exported to and/or displayed on an advertising site.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrases “computing device” or “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A system for external vehicle mapping, comprising:
a computer system including one or more processors and memory;
a data acquisition module configured to receive vehicle data from at least one external data source selected from a manufacturer database, a dealership inventory system, a government motor vehicle record system, or a scanned vehicle identification code;
a mapping module configured to normalize the vehicle data into a standardized data structure representing at least one of vehicle features, options, or packages; and
an inventory management interface configured to provide standardized vehicle data to a dealership inventory system or a third-party application.

2. The system of claim 1, wherein the mapping module comprises a natural language processing engine configured to translate descriptive vehicle information into standardized feature terms.

3. The system of claim 1, wherein the data acquisition module is further configured to process vehicle information derived from optical codes, quick response codes, or other label-based identifiers.

4. The system of claim 1, further comprising a rule set repository configured to store mapping rules, wherein the mapping module applies one or more rules from the rule set repository to the vehicle data.

5. The system of claim 4, wherein the rule set repository is dynamically updated using machine learning based on prior mapping operations.

6. The system of claim 1, wherein the inventory management interface generates an advertising site wireframe including standardized feature descriptions for customer presentation.

7. The system of claim 1, wherein the inventory management interface outputs data formatted for compatibility with a third-party dealer management system.

8. The system of claim 1, wherein the mapping module further comprises a machine learning engine trained to resolve ambiguous or inconsistent vehicle feature descriptions.

9. The system of claim 1, wherein the computer system further comprises a feedback interface configured to receive corrections or confirmations from a human operator, and to update the standardized data structure accordingly.

10. The system of claim 1, wherein the inventory management interface outputs standardized data in a format selected from XML, JSON, or CSV.

11. A method of external vehicle mapping, comprising:
receiving vehicle data from at least one external source;
mapping the vehicle data into a standardized data structure by applying one or more mapping operations including natural language processing or rule-based translation;
storing the standardized data in an inventory management system; and
providing the standardized data to at least one of a dealership inventory interface or a third-party system.

12. The method of claim 11, further comprising processing vehicle data extracted from a vehicle identification number or a quick response code affixed to the vehicle.

13. The method of claim 11, further comprising performing machine learning analysis to refine mapping rules based on discrepancies detected between received data and standardized data.

14. The method of claim 11, wherein providing the standardized data comprises automatically generating a consumer-facing advertisement including standardized vehicle feature descriptions.

15. The method of claim 11, further comprising integrating the standardized data with a remote database accessible by multiple dealerships.

16. A computer-readable medium storing instructions that, when executed by one or more processors, cause the processors to perform operations comprising:
receiving vehicle data from at least one external source;
normalizing the vehicle data into a standardized data structure representing vehicle features, options, or packages;
storing the standardized data in an inventory management database; and
transmitting the standardized data to an external dealership or third-party system.

17. The computer-readable medium of claim 16, wherein the operations further comprise processing the vehicle data using natural language processing to identify equivalent feature terms across different manufacturers.

18. The computer-readable medium of claim 16, wherein the operations further comprise applying one or more machine learning models to predict missing vehicle feature data.

19. The computer-readable medium of claim 16, wherein the operations further comprise outputting standardized vehicle data to a consumer-facing portal in real time.

20. The computer-readable medium of claim 16, wherein the operations further comprise receiving feedback from a dealership operator and updating the standardized data structure based on the feedback.
